(19) United States
(12) Patent Application Publication
(10) Pub. No.: US 2009/0002796 A1
(43) Pub. Date: Jan. 1, 2009

(54) Electrostatic snap-down prevention for membrane deformable mirrors

(75) Inventor: Justin Dennis Mansell, Albuquerque, NM (US)

Correspondence Address: Justin Dennis Mansell, 9223 Silverwood Dr., NE, Albuquerque, NM, 87113, US

(73) Assignee: Mansell, Justin D., Albuquerque, NM (US)

(21) Appl. No.: 11/986,774

(22) Filed: Nov. 26, 2007

Related U.S. Application Data
(60) Provisional application No. 60/861,475, filed on Nov. 28, 2006.

(51) Int. Cl. G02B 26/08

(52) U.S. Cl. 359/224

(57) ABSTRACT

Voltage-controlled electrostatically actuated membrane deformable mirrors suffer from the potential for excessive voltage to induce an electrostatic snap-down event in which the electrostatic force exceeds the mechanical restoring force of the membrane and the membrane surface collapses onto the electrostatic actuators. We present here low-cost solutions to this problem involving two types of mechanical stand-offs integrated with an electrostatic pad array.

### DESCRIPTION

1. Field of the Invention

This invention relates generally to the field of adaptive optics, and in particular to an electrostatic deformable mirror suitable for use in a wide range of adaptive optics applications.

2. Background of the Invention

Adaptive optics is a technique for controlling the spatial phase of light that has been under development for several decades. In a general adaptive optics system, light is reflected from a deformable mirror and a small fraction is split off to illuminate a sensor. The sensor provides feedback to a control computer that adjusts the deformable mirror to change some property of the beam of light. Astronomers have used adaptive optics systems to remove the distortions induced by the atmosphere and achieve higher quality images from large telescopes. Adaptive optics systems have also been used on lasers to improve the beam quality and to shape the intensity profile.

Membrane deformable mirrors have been developed by several groups as a low-cost alternative to conventional piezoelectric or electrostrictive actuator plate-type deformable mirrors. Grosso published results of a metal membrane deformable mirror in 1977. Takami and Zamkotsian published work on nitrocellulose membrane deformable mirrors using a polished Macor electrostatic pad array in 1994 and 2005 respectively. Vdovin and Mansell published work on silicon and silicon nitride membrane deformable mirrors made using MEMS technology in the late 1990's. Finally, Mansell published work in 2006 on a polymer membrane deformable mirror with a low-cost electrostatic pad array made using printed circuit board technology. These membrane deformable mirrors have been shown to be scalable in size, low-cost, high optical quality, and capable of handling significant amounts of laser power.

Although membrane deformable mirrors are ideal for many applications, they do have some potential problems. One of the most significant of these is the potential for damage during operation due to electrostatic snap-down. In membrane mirrors, electrostatic snap-down occurs when the electrostatic force applied to the membrane exceeds the mechanical restoring force and the membrane collapses into the electrostatic pad arrays. In most electrostatic mirrors, snap-down results in damage due to an electrostatic discharge (spark) striking between the membrane and the electrostatic pad array.

Mansell and Vdovin have offered several techniques to address the issue of electrostatic snap-down. Vdovin created a membrane that is resistant to damage by electrostatic snap-down by fabricating a thick membrane of polycrystalline silicon surrounded by layers of silicon nitride. Mansell demonstrated a similar technique with a much thinner polymer (nitrocellulose) membrane. These techniques demonstrate a step forward, but do not solve the problem entirely.

Mansell also demonstrated that a layer of Teflon could be applied over electrostatic pads on a silicon wafer by spin coating it and annealing it to prevent damage due to an electrostatic spark. This technique is better because it prevents the electrostatic spark, but involves an expensive added step and is only effective for work on polished wafers. Furthermore, electrons were often injected into the Teflon coating during electrostatic snap-down and trapped there permanently making the Teflon coating into electret. The permanent charge on the Teflon caused the deformable mirror to deform permanently.

The most recent designs of electrostatically actuated membrane deformable mirrors (Mansell and Vdovin), use low-cost printed circuit board technology for electrostatic pad arrays. We present here techniques for achieving electrostatic snap-down protection that are more conducive to use on membrane deformable mirrors using a printed-circuit board as an electrostatic pad array.

### OBJECTS AND ADVANTAGES OF THE INVENTION

The primary object of this invention is to minimize or eliminate damage due to electrostatic snap-down of a membrane deformable mirror.

### SUMMARY OF THE INVENTION

The above objectives are obtained by creating a mechanical stop for the membrane before it gets close to the printed circuit board electrostatic pad arrays. In the preferred embodiment, a membrane mirror is actuated electrostatically by an electrostatic pad array fabricated using a printed circuit board below the membrane. In normal fabrication, a polymer dielectric coating is applied to the surface of the printed circuit board after fabrication. This coating can be used as protection from electrostatic snap-down. In our experience, this coating is thick enough that it does not breakdown during an electrostatic snap-down event. Furthermore, it appears not to charge like the Teflon coating that Mansell used earlier.

In another embodiment described here, pillars of material are created as electrostatic stand-offs. One version of this technique involves not coating the electrostatic pad arrays or their associated vias with solder and creating separate stand-alone vias that are coated with solder that makes them significantly taller than the surrounding electrostatic pads. The vias with solder then create electrostatic stand-offs that will intercept the membrane during snap-down and prevent it from reaching the electrostatic pads. The stand-offs can be biased at the same voltage as the mirror, or be entirely unbiased. The natural smoothing nature of the plating process that can be used to apply create the solder tends to eliminate any sharp edges which could damage the surface. Another advantage of this technique is that when metal is used properly for the stand-off, it cannot be permanently electrostatically charged.

### BRIEF SUMMARY OF THE FIGURES

FIG. 1 shows a cross-sectional view of an embodiment of the invention in which material has been built up on the surface of the electrostatic pad arrays.

FIG. 2 shows a cross-sectional view of an embodiment of the invention in which a non-conducing layer of material is coated over all the electrostatic pads to prevent an electrostatic spark from forming and creating damage.

FIG. 3 shows a three dimensional rendering of a typical membrane deformable mirror showing one configuration of electrostatic stand-offs interleaved with the electrostatic pad arrays.

### DETAILED DESCRIPTION

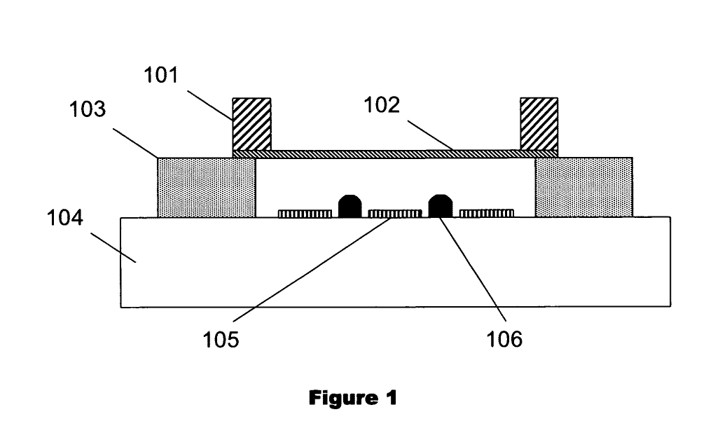

FIG. 1 illustrates an embodiment of the invention in which a deformable membrane 102 attached to a frame 101 is placed over an electrostatic pad array made of printed circuit board (PCB) 104. A spacer 103 is placed between the PCB substrate that makes electrostatic pad array and the frame of the deformable mirror membrane to establish an actuation gap between the pads and the mirror. Placed between the pads 105 are pieces of solid material 106 that will be taller than the pads such that the membrane will stop on the bumps of material during an electrostatic snap-down event before touching the electrostatic pads or getting close enough to the pads to allow an electrostatic discharge (spark) to be created. These pieces of material 106 are to be henceforth referred to as electrostatic stand-offs. The electrostatic stand-offs can be made of virtually any solid material, but will not develop a charge if they are made of a metal. One easy way to create the electrostatic stand-offs is to use a solder layer of a printed circuit board which is a plated layer of solder on the surface of pads. In addition to plating, the electrostatic stand-offs can be created using any of a number of methods including but not limited to screen printing, evaporation, syringe deposition, or epoxy attachment. One advantage of plating deposition of the electrostatic stand-offs is that the surface is typically quite smooth, thus minimizing the risk of mechanical damage due to the surfaces touching. Conductive electrostatic stand-offs can be left entirely disconnected from any potential (floating) or kept at the same potential as the mirror membrane to avoid discharge between the membrane and the stand-offs during snap-down. The electrostatic standoffs can be made as a via through the PCB as well. This via variation offers the potential for more easily wiring the stand-offs to a potential in another layer. The via-type electrostatic standoffs could also be created as a blind via which does not entirely pass though the PCB but terminates at a layer inside the PCB. Through-hole vias also provide an avenue for air to pass in and out of the cavity formed by the mirror surface and the electrostatic pad array which can affect the air damping.

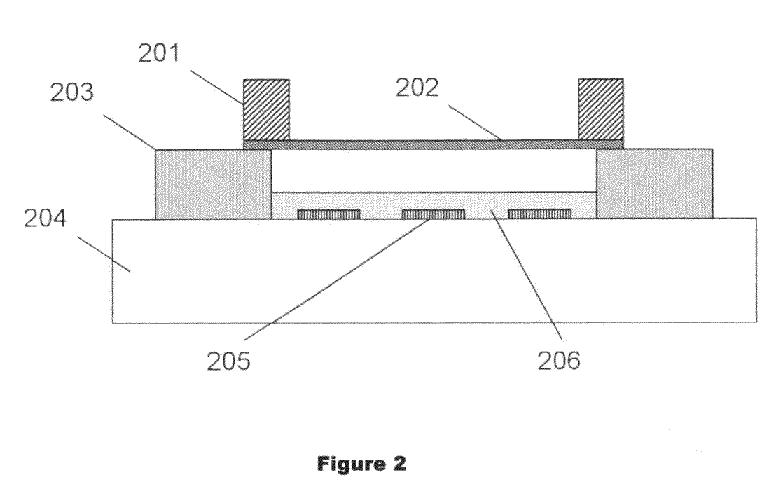

FIG. 2 illustrates an embodiment of the invention in which the mirror membrane 202, which is mounted in a frame 201 on a spacer 203, is prevented from reaching the electrostatic pad array on the printed circuit board (PCB) 204 by a dielectric coating that is applied over the electrostatic pads 205. PCB manufacturers commonly coat their PCBs a liquid photo-imageable solder mask to prevent the solder deposition from being applied to all the exposed copper on the board. This solder mask typically is left on the board and is a great dielectric electrostatic snap-down stand-off. Some manufacturers coat the PCB with silicone, epoxy, acrylic, urethane, or parylene to protect the board from damage due to contamination, salt spray, moisture, fungus, dust and corrosion caused by harsh or extreme environments. This layer can be used as a dielectric electrostatic stand-off as well.

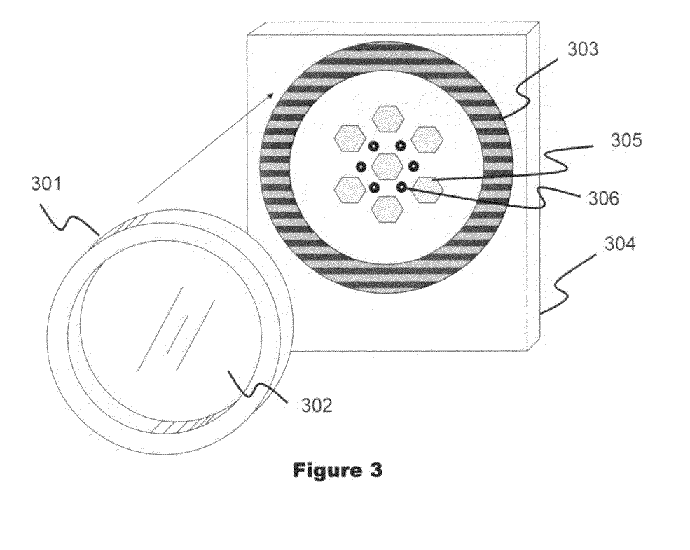

FIG. 3 shows a 3D rendering of a deformable mirror with the deformable mirror membrane 302 and its frame 301 are separated from the printed circuit board 304. This 3D rendering of the printed circuit board surface illustrates the placement of the spacer 303, electrostatic pad arrays 305, and via-style electrostatic spacers 306.

What is claimed is:

1. An active mirror comprising a reflective membrane with a conductive layer attached to a printed circuit board having
a. at least one electrostatic actuator and
b. a dielectric coating over the electrostatic actuator capable of preventing damage due to electrostatic snap-down.

2. An active mirror comprising a reflective membrane with a conductive layer attached to a printed circuit board having
a. at least one electrostatic actuator and
b. a piece of material thicker than the electrostatic pads such that the membrane will stop on this material during an electrostatic snap-down event before reaching the electrostatic pads.

3. The active mirror of claim 1 or claim 2 where the membrane is made of a polymer.

4. The active mirror of claim 1 or claim 2 where the membrane is a nitrocellulose pellicle.

5. The active mirror of claim 1 or claim 2 where the membrane is coated with a metal for reflectivity or conductivity.

6. The active mirror of claim 3 where the metal coating is aluminum.

7. The active mirror of claim 1 or claim 2 where the frame of the mirror membrane is integrally formed as part of the printed-circuit board.

8. The active mirror of claim 1 or claim 2 where the optically reflective layer and the conductive layer are the same layer.

9. The active mirror of claim 1 where the dielectric coating is the solder mask.

10. The active mirror of claim 9 where the solder mask is liquid photo-imageable material.

11. The active mirror of claim 2 where the material for intercepting the membrane during an electrostatic snap-down event is the solder layer normally used by printed-circuit board manufacturers.

12. The active mirror of claim 9 where the solder is put on to a surface pad like that used for surface mount components.

13. The active mirror of claim 9 where the solder is applied to a via in the printed circuit board.
